(19) United States
(12) Patent Application Publication
(10) Pub. No.: US 2024/0343478 A1
(43) Pub. Date: Oct. 17, 2024

(54) BIN ATTACHMENT

(71) Applicant: Raymond SHARPE, North Epping (AU)

(72) Inventor: Raymond SHARPE, North Epping (AU)

(21) Appl. No.: 18/683,770

(22) PCT Filed: Aug. 22, 2022
(86) PCT No.: PCT/AU2022/050947

§ 371 Date: Feb. 14, 2024

(30) Foreign Application Priority Data
Aug. 23, 2021 (AU) 2021221434

(51) Int. Cl. B65F 1/16

(52) U.S. Cl. CPC B65F 1/1615; B65F 1/1623; B65F 2001/1669

(57) ABSTRACT

A bin attachment for closing a pivotally openable lid of a bin, comprising:
a securing means for releasably securing the bin attachment to the bin via a handle thereof;
a lid engaging portion; and
a stopper configured to engage a body of the bin and resist opening of the lid beyond a maximum amount such that, when unsupported, the lid returns to a closed position.

### FIELD OF THE INVENTION

The present patent specification relates to a bin attachment. In particular, the attachment is securable to a bin with a lid and assists with keeping the lid closed.

### BACKGROUND

FIGS. 1 and 2 show a household bin 2, commonly known as a ‘wheelie bin’, having a body 4 in which refuse can be thrown, and a lid 6 that is pivotably openable relative to the body 4 to open and close the body 4 of the bin 2. The bin 2 comprises a substantially cylindrical and rearward pull handle 8 via which the bin 2 can be moved, (e.g., via ground-engaging wheels). With such bins 2, the lid 6 is generally pivotable relative to the body 4 about an axis extending through or close to the longitudinal axis of the elongate cylindrical handle 8.

The lid 6 of such bins 2 is usually openable to a large extent. From the closed lid 6 position shown in FIG. 1, wherein the lid 6 can be said to be at an angle of zero degrees, the lid 6 would typically be pivotable up to approximately 270 degrees (anti-clockwise) such that an upper surface thereof faces and/or is engaged with a rear wall of the body 4 of the bin 2. In this position, the lid 6 is inclined to stay in the open position under its own weight. In particular, it will be understood that the lid 6 swings freely about its pivot axis. As such, if the lid 6 is held open at any angle, once released, the lid 6 will pivot under its own weight toward either the closed position (i.e. lid 6 at zero degrees) or fully open position (I.e., lid 6 at approximately 270 degrees and/or with an upper surface thereof facing the rear wall of the body 4 of the bin.) Referring to FIG. 1, under controlled conditions (e.g., no wind, flat ground etc.), it can be imagined that if the lid 6 were opened to an angle that is less than approximately 90 degrees and then released, the lid 6 would, under its own weight, pivot back to the closed position at zero degrees.

However, if the lid were opened to an angle that is more than approximately 90 degrees and then released, the lid 6 would, under its own weight, pivot to a fully open position wherein the upper surface of the lid 6 faces or is proximate to the rear wall of the body 4 of the bin 2. This can be problematic, particularly if the lid 6 is unintentionally opened: rubbish within the bin 2 can escape (e.g., if the bin 2 is tipped over); birds, flies and other pests can access the rubbish; rainfall can enter the open bin 2; odour can more readily escape from the bin 2; and bypassers may be tempted to dispose of their rubbish in the open bin 2. As such, it is important to keep the lid 6 of the bin 2 closed outside of the brief periods during which refuse is deliberately being discarded into the bin 2 or collected therefrom.

However, in ordinary use, there are various circumstances and situations that can cause the lid 6 of the bin 2 to open and remain open. For example: strong winds can blow the lid 6 open; animals may pry the lid 6 open, particularly if the bin 2 is overflowing; and a garbage truck placing the bin 2 back on the ground after rubbish collection can do so in a manner that leaves the lid 6 open.

There is a need to address the above, and/or at least provide a useful alternative.

### SUMMARY

According to an aspect of the present invention, there is provided a bin attachment for closing a pivotally openable lid of a bin, comprising:
a securing means for releasably securing the bin attachment to the bin via a handle thereof;
a lid engaging portion; and
a stopper configured to engage a body of the bin and resist opening of the lid beyond a maximum amount such that, when unsupported, the lid returns to a closed position.

In embodiments of the bin attachment:
the lid engaging portion comprises a first arm configured to engage an upper surface of the lid;
the stopper comprises a second arm extending at an angle relative to the first arm; and
the securing means is disposed generally between the first and second arms and comprises an opening configured to rotatably receive the bin handle such that at least one of the arms pivot about the handle as the lid is pivoted.

In use, as the lid is opened, the attachment correspondingly pivots about the handle, and wherein when the lid is opened to or beyond the maximum amount, the stopper engages the body of the bin and resists against the attachment from pivoting further, thereby resisting against the lid from being opened further.

In embodiments of the bin attachment, the angle between the first and second arms is such that the lid cannot be opened beyond approximately 90 degrees from an upper plane of the body of the bin.

In embodiments of the bin attachment:
the arms are interconnected by the securing means; and
the securing means comprises a resilient clip configured to be urged over the bin handle so as to be releasably securable thereto. In one example, the resilient dip tightens or closes over the handle as the lid is opened so as to resist against opening thereof.

In certain embodiments, the stopper is generally resilient and spring-biases the lid toward the closed position.

In one example, as the lid is opened to a first extent, flexing of the resilient dip provides a first resistance against opening of the lid, and as the lid is opened to a second extent, flexing of the stopper provides a second resistance against opening of the lid.

In one example, the stopper may comprise a tail end that curves toward the lid engaging portion and is configured, in use, to abut the body of the bin. It is envisaged that, in use, the stopper may be configured to abut against the body of the bin when the lid is opened to and beyond approximately 30 degrees from an upper plane of the body of the bin. In certain embodiments, the stopper is configured to resiliently deform and spring-bias the lid toward the closed position as the lid is opened beyond approximately 30 degrees.

In certain embodiments, the lid engaging portion may comprise a head end that curves toward the stopper and is configured, in use, to abut an upper surface of the lid. The curved lid engaging portion may be configured to resiliently deform and spring-bias the lid to the closed position as the lid is opened.

It is envisaged that the bin attachment may at least be partially formed from a resilient material. In one example, the attachment may be integrally formed.

### BRIEF DESCRIPTION OF THE DRAWINGS

An embodiment of the invention will now be described, by way of example only, with reference to the accompanying drawings in which:

FIG. 1 is a side perspective view of a bin fitted with a bin attachment according to a first embodiment, the bin lid shown in a closed position;

FIG. 2 is a rear perspective view of the bin and bin attachment of FIG. 1, the bin lid shown opened to a reduced maximum amount limited by the bin attachment;

FIG. 3 is a top perspective view of the bin attachment of FIG. 1;

FIG. 4 is a side view of the bin attachment of FIG. 3;

FIG. 5 is a rear perspective view of the bin attachment of FIG. 3;

FIG. 6A is a side view of a bin attachment according to a second embodiment;

FIG. 68 is a side view of the attachment according to FIG. 6A in a configuration which resists against further opening of a bin lid;

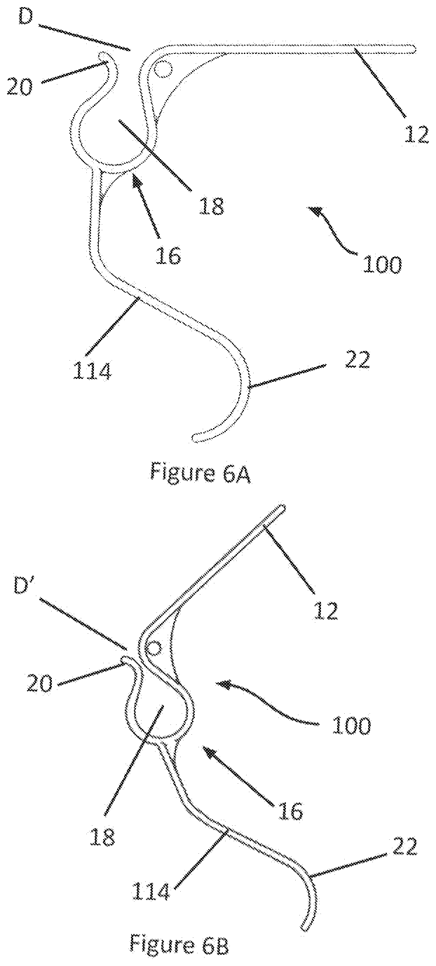

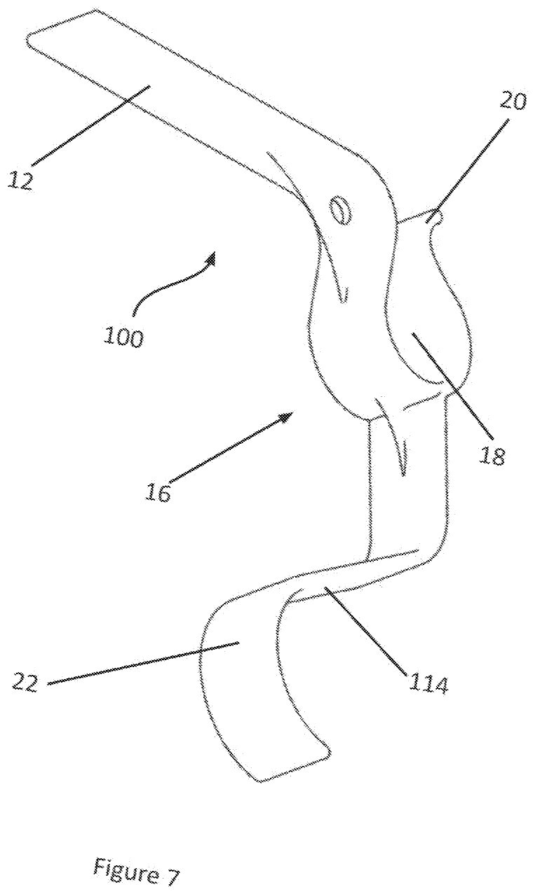

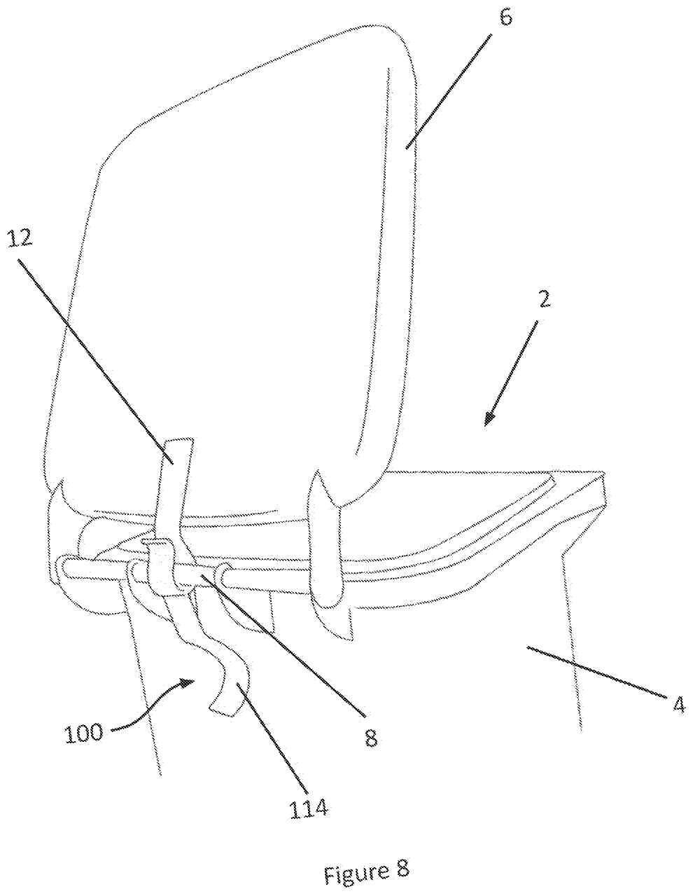

FIG. 7 is a bottom perspective view of the bin attachment of FIG. 6;

FIG. 8 is a rear perspective view of a bin fitted with the bin attachment of FIG. 6, the bin lid shown opened to a reduced maximum amount as limited by the bin attachment; and

FIG. 9 is a side view of a bin attachment according to a third embodiment.

### DETAILED DESCRIPTION

The present bin attachment 10 is depicted as a substantially integrally formed product. For example, it can be formed from a single piece of moulded plastic. As such, the attachment 10 may be easily and cost-effectively mass-manufactured.

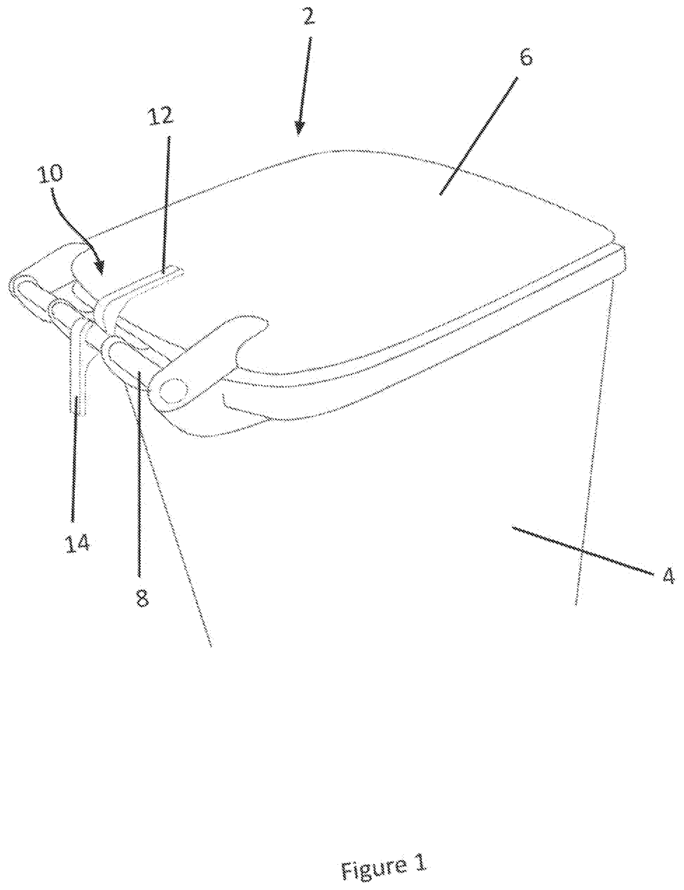

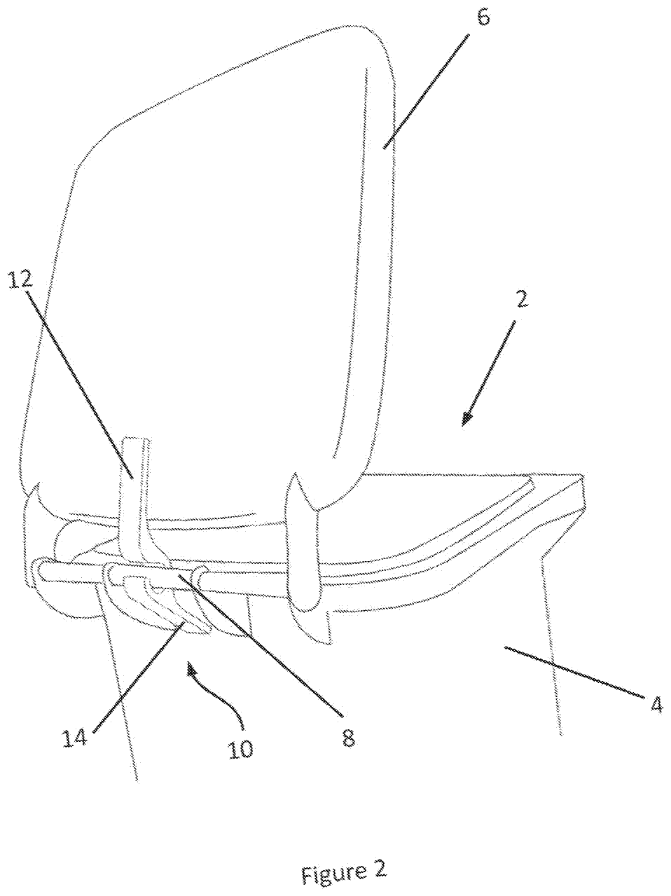

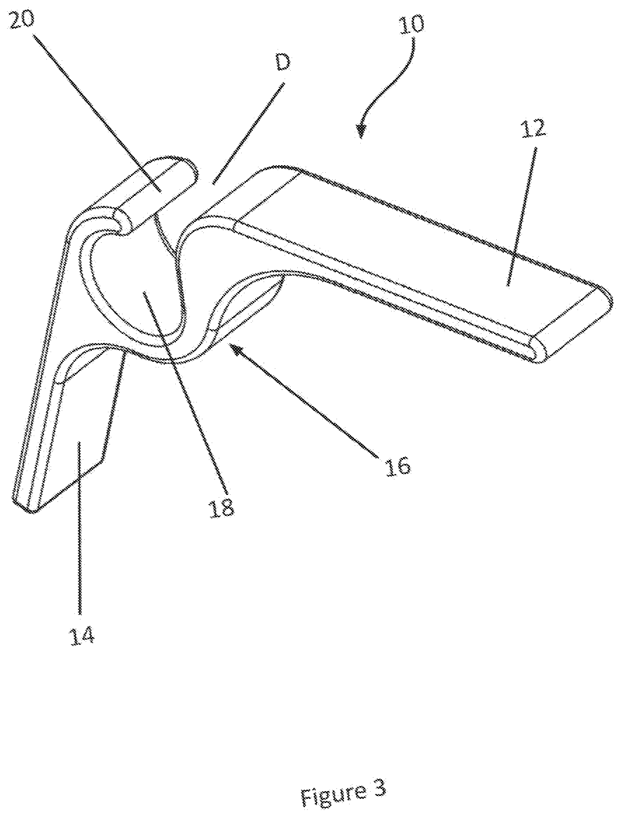

Referring to FIGS. 1 and 2, the attachment 10 comprises:
a lid engaging portion, depicted as a generally rectangular arm 12, configured to engage against a top surface of the lid 6 of the bin 2;
a stopper, depicted as a second generally rectangular arm 14, configured to engage against the body 4 of the bin 2; and
a securing means 16, depicted as a clip-like means interconnecting the two arms 12, 14 and having a cylindrical opening 18 configured to dip over and rotatably receive the cylindrical handle 8 of the bin 2.

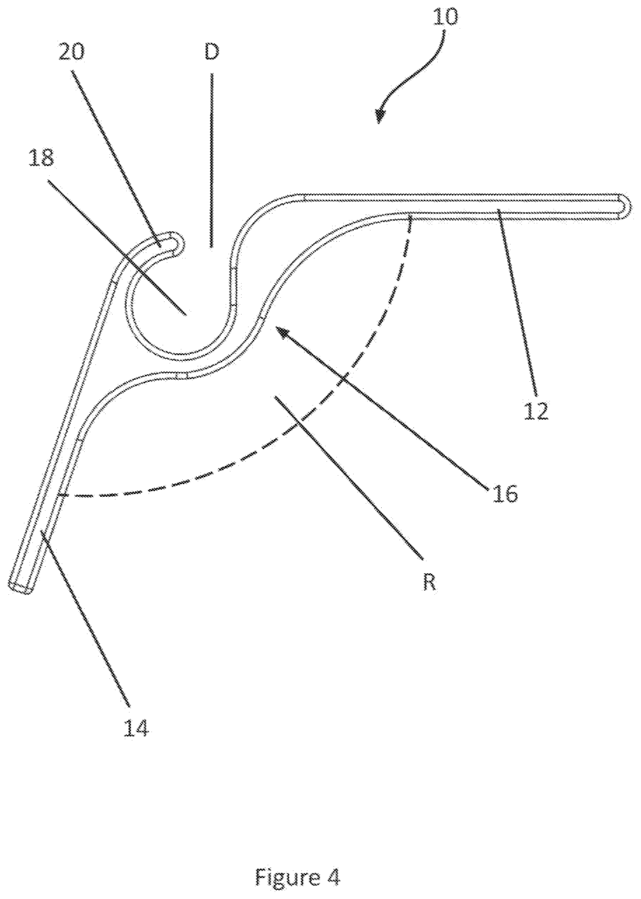

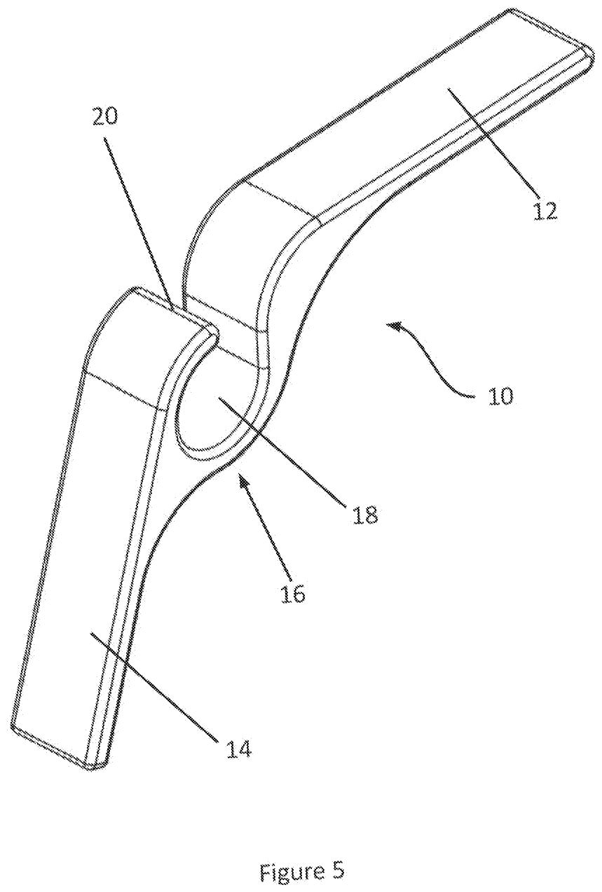

Referring to FIGS. 3 and 4, the securing means 16 comprises a curved lip 20 extending from the body engaging arm 14 of the attachment 10. The lip 20 projects towards a rear of the lid engaging arm 12 so as to define a space D therebetween through which the handle 8 can fit into the opening 18. It is envisaged that the width of the space D (i.e., the distance between lip 20 and the rear surface of the lid engaging arm 12, as viewed from FIG. 4) is less than the diameter of the handle 8 of the bin 2. In this way, to secure the attachment 10 to the handle 8 of the bin 2, the attachment 10 is pressed against the handle 8 so that the lip 20 is urged away from the rear surface of the lid engaging arm 12, thereby temporarily increasing the space D so that the handle 8 can enter and be located within the cylindrical opening 18 of the attachment 10.

Upon receipt of the handle 8 in the opening 18, the lip 20 can then return to its unurged position, thereby blocking the handle 8 from escaping through the reduced gap D unless sufficient force is applied to open the dip-like securing means 16 of the attachment 2. Of course, one can readily remove the attachment 10 from the handle 8 simply by reversing the process; e.g., the attachment 10 can be pulled away from the handle 8 so that the resilient securing means 16 opens up (i.e., the gap D between the lip 20 and the rear surface of the first arm 12 is temporarily widened so that the handle 8 can be withdrawn from the opening 18 and thus securing means 16. In this way, the attachment 10 can be readily removed from the bin 2 if it is desired to open the lid 6 more fully (e.g., to facilitate cleaning of the bin 2). This functionality of the attachment 2, and in particular the resilience of the securing means 16 thereof, is facilitated by the attachment 2 being at least partially made from a resilient material, such as plastic, which can temporarily deform under stress, and return to its original form once the stress has been removed.

It is envisaged that the diameter of the cylindrical opening 18 of the attachment 10 is approximately equal to or slightly larger than the diameter of the cylindrical handle 8 of the bin 2. In this way, once the attachment 10 is dipped to the handle 8, the attachment 10 can readily rotate or pivot about the handle 8.

FIG. 1 shows the attachment 10 releasably secured to the bin 2 via the handle 8 thereof. The elongate first arm 12 is engaged against the lid 6 of the bin 2. The elongate second stopper arm 14 extends downwardly from the handle 8 and is spaced from the rear wall of the body 4 of the bin 2. In opening the lid 6 of the bin 2 (e.g., towards the open position shown in FIG. 2), the attachment 10 is pivoted rearwardly by virtue of the lid's 6 engagement with the first arm 12 of the attachment 10. As such, in response to the lid 6 being opened, the attachment 10 pivots or rotates about the longitudinal axis extending through the handle 8 of the bin 2.

When the lid 6 is opened to a predetermined maximum amount (as shown in FIG. 2), the stopper arm 14 of the attachment 20 is configured to physically abut and engage against a rear wall of the body 4 of the bin 2. This engagement of the stopper 14 acts to stop the attachment 10 from rotating further, since the rear wall of the body 4 of the bin 2 now obstructs the attachment 10 from further rotation about the bin handle 8. As a result, the lid 6 is also obstructed, via the first arm 12, from being opened beyond this maximum amount as shown in FIG. 2.

In particular, the maximum amount or extent to which the lid 6 of the bin 2 can be opened is an amount such that, if the lid 6 were unsupported (e.g., the lid 6 is not manually supported), then the lid 6 falls under its own weight and pivots back to the closed position (FIG. 1). To this end, it is important that the angle R (FIG. 4) between the arms 12, 14 and the lengths thereof are configured such that when the attachment 10 is secured to the bin 2, the attachment 10 functions to restrict or limit the lid 6 from being opened beyond an extent after which the lid 6 would no longer fall to a closed position under its own weight.

Embodiments of the present bin attachment 10 thus provide a relatively cost-effective and easily manufacturable product that is simple to use and effective at retaining the desired functionality of bins 2 (that is, allowing users to easily open and close the lid 6 in order to deposit refuse), while limiting the maximum extent to which the lid 6 is openable such that, if left unsupported or inadvertently opened, the lid 6 is caused to automatically return to a closed position under its own weight.

Many modifications of the present bin attachment will be apparent to those skilled in the art without departing from the scope of the present invention. For example, while the attachment 10 is shown with a stopper 14 configured to engage the body 4 of the bin 2 at or close to the point when the lid 6 has reached its maximum openable amount, certain embodiments of the attachment 10 may comprise a stopper 14 that engages the body 4 earlier, or even continuously engages with the body 4 of the bin 2 during use. For example, the stopper arm 14 might be formed from a relatively resilient, spring-like material configured to engage the body 4 of the bin 2 earlier in the lid opening process. Such an attachment might allow the lid 6 of the bin 2 to be manually urged beyond the point shown in FIG. 2, and may even allow the lid 6 to be urged completely open, however upon release of the manually applied force, the spring-like attachment, which is biased to return to an unstressed state, may then act to return the lid 6 to the closed position.

Of course, the resilient or spring-like functionality of the stopper 14 may not be limited to the stopper. In another embodiment, the stopper 14 may be relatively rigid and be in constant engagement with the body 4, whereas the lid engaging arm 12 functions like a spring to urge the lid 6 back to the closed position. Of course, both the stopper 14 and the lid engaging arm 12 may be sufficiently resilient to facilitate closing of the lid 6.

FIGS. 6 to 8 show an embodiment of a bin attachment 100 wherein like reference numerals denote like features. The stopper arm 114 of this attachment 100, rather than being generally planar and elongate as per the previous embodiment 10, curves inwardly so as to, in use, project inwardly toward the rear wall of the bin 2. Viewed from the side, as per FIG. 6A, the stopper arm 114 has a generally S-shaped profile.

FIG. 6A shows the bin attachment 100 in an unurged or relaxed configuration. For example, this is how the attachment 100 would appear when attached to a bin handle 8 with the lid 6 closed. FIG. 66 shows the bin attachment in an urged or ‘resisting’ configuration. For example, this is how the attachment 100 would appear when attached to the bin handle 8 and the lid 6 has been opened to a certain extent.

As per the previous embodiment of the attachment 10, the present attachment 100 also comprises a curved lip 20 extending from the body engaging arm 114 of the attachment 100. The lip 20 projects towards a rear of the lid engaging arm 12 so as to define a space D therebetween through which the handle 8 can fit into the opening 18. In use, when the bin lid 6 is initially opened to a first extent, the lid engaging arm portion 12 of the attachment 100 flexes backwards towards the curved lip 20, resulting in the reduced gap D′ as per FIG. 66. This flexing of the attachment 100 provides a resisting force which acts to resist opening of the bin lid 6. Moreover, this closure of the gap results in the opening 18 (i.e., the cylindrical clip defining the opening 18) closing more tightly over the bin handle 8 so as to further resist opening of the bin lid 6. Once the gap D′ cannot be reduced or closed any further and/or the opening 18 cannot be closed any tighter over the handle 8, additional resistance against opening of the bin lid 6 may be provided by the curved tail-like 22 of the stopper arm 114, as discussed below.

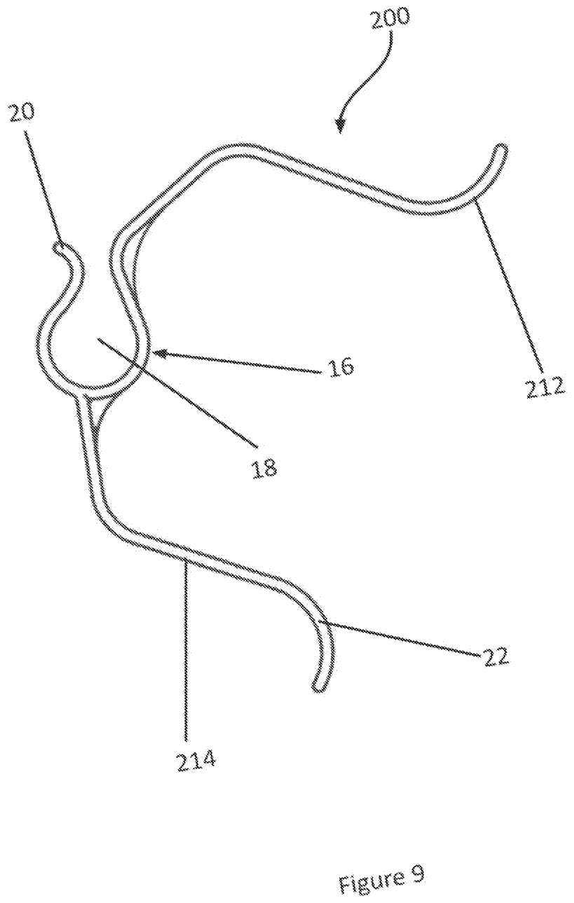

In use, the inwardly curved portion 22 of the stopper arm 114 abuts against the rear wall of the bin 2, and may abut earlier in the opening range of the lid 6 as compared with the previous embodiment of the attachment 10. For example, the stopper arm 114 could abut against the rear wall of the bin 2 when the lid 6 is opened to about 30 degrees (other angles are of course within the scope of the present specification), and begin gradually resisting further opening of the lid 6 as the lid 6 is opened further toward about 90 degrees (again, other angles are of course within the scope of the present specification). In one example, it is envisaged that the flexing of the lid engaging arm 12 to reduce the gap from D to D′ provides an initial resistance against opening of the bin lid 6, and once the gap D′ cannot be closed further, additional resistance is provided by the flexing of the curved stopper 22, as shown in FIG. 68. Of course, in certain embodiments, it is envisaged that resistance from both the flexing of the lid engaging arm 12 and the flexing of the stopper arm 114 work together, though perhaps providing different resistances based on the open angle of the bin lid 6.

In one example, as the lid 6 is opened beyond 90 degrees, it is envisaged that the curved portion 22 of the stopper arm 114 resiliently deforms toward a less curved configuration (as shown in FIG. 68), and the resilience of the arm 114 is such that it is inclined to return to its curved state. In this way, the curved stopper arm 114 spring-biases the lid 6 back toward the closed position. This resistance against further opening of the lid 6 may, for example, discourage and/or prevent animals and the like from holding the lid 6 open to access contents in the bin 6.

FIG. 9 shows another embodiment of a bin attachment 200 wherein like reference numerals denote like features. This attachment 200 is similar to that of FIGS. 6 to 8, a difference being that the lid engaging arm 212 also comprises a kink or downwardly curved portion which contacts the lid. This arm 212 is similarly configured to flex into a straighter configuration and spring-bias the bin lid 6 toward the closed position. In the depicted embodiment, it is envisaged that in use, the stopper arm 214 is in contact with a rear wall of the bin 2 even when the lid 6 thereof is closed. As such, the attachment 200 resists opening of the bin lid 6 as the lid 6 is opened.

Throughout this specification and the claims which follow, unless the context requires otherwise, the word “comprise,” and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

The LidStop device does not engage with the bin lid and the rear of the bin until the lid is lifted to around 30 degree or there about. The degree may differ with various bins sizes and handle positions relative to the rear of the bin.

1. A bin attachment for closing a pivotally openable lid of a bin, comprising:
a securing means for releasably securing the bin attachment to the bin via a handle thereof;
a lid engaging portion; and
a stopper configured to engage a body of the bin and resist opening of the lid beyond a maximum amount such that, when unsupported, the lid returns to a closed position.

2. The bin attachment of claim 1, wherein:
the lid engaging portion comprises a first arm configured to engage an upper surface of the lid;
the stopper comprises a second arm extending at an angle relative to the first arm; and
the securing means is disposed generally between the first and second arms and comprises an opening configured to rotatably receive the bin handle such that at least one of the arms pivots about the handle as the lid is pivoted.

3. The bin attachment of claim 2, wherein in use, as the lid is opened, the attachment correspondingly pivots about the handle, and wherein when the lid is opened to or beyond the maximum amount, the stopper engages the body of the bin and resists against the attachment from pivoting further, thereby resisting against the lid from being opened further.

4. The bin attachment of claim 3, wherein the angle between the first and second arms is such that the lid cannot be opened beyond approximately 90 degrees from an upper plane of the body of the bin.

5. The bin attachment of any one of claim 2, wherein:
the arms are interconnected by the securing means; and
the securing means comprises a resilient clip configured to be urged over the bin handle so as to be releasably securable thereto.

6. The bin attachment of claim 5, wherein the resilient clip tightens or closes over the handle as the lid is opened so as to resist against opening thereof.

7. The bin attachment of claim 3, wherein the stopper is generally resilient and spring-biases the lid toward the closed position.

8. The bin attachment of claim 6, wherein as the lid is opened to a first extent, flexing of the resilient clip provides a first resistance against opening of the lid, and as the lid is opened to a second extent, flexing of the stopper provides a second resistance against opening of the lid.

9. The bin attachment of claim 1, wherein the stopper comprises a tail end which curves toward the lid engaging portion and is configured, in use, to abut the body of the bin.

10. The bin attachment of claim 3, wherein in use, the stopper is configured to abut against the body of the bin when the lid is opened to and beyond approximately 30 degrees from an upper plane of the body of the bin.

11. The bin attachment of claim 10, wherein the stopper is configured to resiliently deform and spring-bias the lid toward the closed position as the lid is opened beyond approximately 30 degrees.

12. The bin attachment of claim 1, wherein the lid engaging portion comprises a head end which curves toward the stopper and is configured, in use, to abut an upper surface of the lid.

13. The bin attachment of claim 12, wherein the lid engaging portion is configured to resiliently deform and spring-bias the lid to the closed position as the lid is opened.

14. The bin attachment of claim 11, being at least partially formed from a resilient material.

15. The bin attachment of claim 14, the attachment being integrally formed.
